(19) United States
(12) Patent Application Publication
(10) Pub. No.: US 2007/0251710 A1
(43) Pub. Date: Nov. 1, 2007

(54) Ground Drilling Hammer and the Driving Method

(76) Inventor: Byung-Duk Lim, Jeollabuk-do (JP)

Correspondence Address: LEXYOUME IP GROUP, LLC, 1233 TWENTIETH STREET, N.W., SUITE 701, WASHINGTON, DC, 20036, US

(21) Appl. No.: 11/720,219

(22) PCT Filed: Dec. 1, 2005
(86) PCT No.: PCT/KR05/04075

§ 371 Date: May 25, 2007

(30) Foreign Application Priority Data
Dec. 7, 2004 (KR) 10-2004-0102256
Apr. 8, 2005 (KR) 10-2005-0029503
Nov. 22, 2005 (KR) 10-2005-0111836

(51) Int. Cl. B25D 9/00

(52) U.S. Cl. 173/109

(57) ABSTRACT

Disclosed herein is a pneumatic operated hammer for rock drilling, the hammer comprising a cylindrical casing, a back head mounted at an upper portion of the casing, a check valve for opening/closing a compressed air passageway in the casing, a guide for supporting the check valve, a piston adapted to ascend and descend with compressed air in the casing, and a button bit for performing a drilling work through the striking of the piston. The piston is extended to a certain length to conform to the work condition of the pneumatic hammer to thereby prevent a water back-flow phenomenon in which underground water, etc., is introduced into the drilling equipment during the drilling work, compressed air passageways and variable compressed air chambers are formed between the piston and the casing so that when the piston ascends by the compressed air, it abruptly ascends at a load-free state, and the piston has axial portions with a reference diameter and different outer diameters so that it is possible to manufacture a hammer bit having a plurality of variable compressed air chambers formed between the casing the piston to fit for the work capacity. The piston ascended in a load-free state strikes the button bit with its rapid and strong striking force produced by the compressed air supplied from the variable chambers while abruptly descending to thereby perform the drilling work.

### TECHNICAL FIELD

The present invention relates to a pneumatic operated hammer for use in earth and rock drilling and boring operations and driving method thereof, and more particularly, to such a drilling pneumatic hammer in which air passageways are arranged concentrically at regular intervals about a central axis of the back head to supply the compressed air required for driving the hammer in a central and distributed manner, in which the piston is extended to a certain length to conform to the work condition of the pneumatic hammer to thereby prevent a water back-flow phenomenon in which underground water, etc., is introduced into the drilling equipment during the drilling work, in which the outer diameters of respective axial portions of the piston are formed differently from one another to form variable compressed air chambers between the piston and the casing so that when the piston ascends by the compressed air, it abruptly ascends at a load-free state, and in which the piston strikes the button bit with its strong striking force to perform the drilling work while the piston abruptly descends due to the compressed air applied integrally in a plurality of variable air chambers, thereby improving the drilling work efficiency and saving the time and cost required for the maintenance and repair of the drilling equipment, and a driving method thereof.

### BACKGROUND ART

As examples of a pneumatic operated hammer for earth and rock drills, a down-on-the hole hammer is disclosed in European patent EP B1 0 336 010 or U.S. Pat. No. 4,015,670. However, the above patent has demerits in that a known piston of the down-on-the hole hammer is geometrically very complex, its repair and maintenance is very difficult and a mechanical trouble occurs frequently to thereby degrade a working efficiency. Further, when the lower end of the piston strikes an anvil portion of a drill bit, a compressed air supply is interrupted to thereby hinder the operation of the hammer.

As an improvement over such a conventional invention, there is disclosed Korean Patent Laid-Open Publication No. 2001-52919 published on Jun. 25, 2001 and entitled “percussive down-the-hole-rock drilling hammer”. However, this patent also embraces shortcomings in that the supply of pressurized air is performed only through an aperture of a central passageway of a piston and outlet apertures of a feed tube, so that the function of the compressed air for the ascending and descending, i.e., the upward and downward movements of a piston is not carried out efficiently, and since the arithmetic ratio of resistance and density of the component parts is applied to the drilling hammer, the drilling hammer does not have a function capable of preventing back flow of underground water or sludge at the time of the actual drilling work.

Furthermore, since a check valve for selectively blocking pressurized air is readily worn or exceeds fatigue strength due to a frequent striking to thereby suffer a partial crack or damage, leading to the frequent stopping of the drilling work. As a result, the work efficiency is deteriorated and the drilling equipment is not easy to repair and maintain.

### DISCLOSURE OF INVENTION

### Technical Problem

Accordingly, the present invention has been made to solve the above-described problems, and it is an object of the present invention to provide a pneumatic operated hammer for use in earth and rock drilling and boring operations and driving method thereof, in which the upward and downward movement of a piston using compressed air is efficiently carried out a new design of the supply scheme of compressed air, in which the piston is fabricated to have a predetermined length fitting for a desired drilling work so that it is possible to prevent a degradation in a function or a damage of the hammer due to water back-flowing into the drilling hammer, in which the flow structure of compressed air is efficiently improved through an additional formation of variable compressed-air chambers so that the ascending and descending of the piston is performed smoothly to thereby enhance the drilling work efficiency, and in which the environment of the drilling work is greatly improved in terms of time and economic aspect.

Technical Solution

The above object is accomplished by the construction and operation principle of the present invention, in which the feed structure of compressed air is innovatively designed in a central feed scheme to improve the flow of compressed air so that compressed air in the central hollow space of a back head is distributed through compressed air passageways arranged concentrically in the back head and the compressed air is fed to a plurality of compressed-air chamber to effect the upward and downward reciprocation of the piston, the compressed-air chambers being formed by a space defined between the piston and a casing, and in which the length of the piston calculated on a structural and mechanical basis is set to prevent the back flow of water into the drilling equipment.

According to the present invention to which this operation principle is applied, the compressed-air chambers are formed between the piston and the casing to enable the piston to be reciprocatingly moved upwardly and downwardly within the casing to which compressed air is fed, and the rapid upward and downward movement of the piston is effected by the compressed air fed through air passageways communicating with the compressed-air chambers to thereby further enhance its striking force.

### BRIEF DESCRIPTION OF THE DRAWINGS

Further objects and advantages of the invention can be more fully understood from the following detailed description taken in conjunction with the accompanying drawings, in which:

FIG. 1 is a cross-sectional view of a pneumatic operated hammer for rock drilling in an assembly state according to a first embodiment of the present invention;

FIG. 2 is an exploded perspective view of FIG. 2;

FIG. 3 is a view illustrating the construction of a back head 400 in FIG. 1, wherein FIG. 3(a) is a front view of the back head, FIG. 3(b) is a right side view of FIG. 3(a), and FIG. 3(c) is a cross-sectional view taken along the line S-S′ of FIG. 3(b);

FIG. 4 is a view illustrating the construction of a piston 200 of FIG. 1, wherein FIG. 4(a) is a front view of the piston, FIG. 4(b) is a right side view of FIG. 4(a), FIG. 4(c) is a left side view of FIG. 4(a), and FIG. 4(d) is a cross-sectional view taken along the line S-S′ of FIG. 4(b);

FIG. 5 is a view illustrating the construction of a guide 600 in FIG. 1, wherein FIG. 5(a) is a front view of the guide, FIG. 5(b) is a right side view of FIG. 5(a), and FIG. 5(c) is a cross-sectional view taken along the line S-S′ of FIG. 5(b);

FIG. 6 is a cross-sectional view illustrating the construction of a check valve 500 in FIG. 1;

FIG. 7 is a view illustrating the construction of a drill chuck in FIG. 1, wherein FIG. 7(a) is a front view of the drill chuck, FIG. 7(b) is a right side view of FIG. 7(a), and FIG. 7(c) is a cross-sectional view taken along the line S-S′ of FIGS. 7(b), and 7(d) is a cross-sectional view taken along the line A-A′ of FIG. 7(a);

FIG. 8(a) to 8(d) are cross-sectional views illustrating the sequential driving process of the pneumatic operated hammer for rock drilling according to the present invention of FIG. 1;

FIG. 9 is a cross-sectional view of a pneumatic operated hammer for rock drilling in an assembly state according to a second embodiment of the present invention;

FIG. 10 is a view illustrating the construction of a piston 20 of FIG. 9, wherein FIG. 10(a) is a front view of the piston, FIG. 10(b) is a top plan view of FIG. 10(a), FIG. 10(c) is a bottom view of FIG. 10(a), and FIG. 10(d) is a cross-sectional view taken along the line 3-3′ of FIG. 10(c);

FIG. 11 is a view illustrating the construction of a sealing support ring, wherein FIG. 11(a) is a view of a semi-circular piece constituting the sealing support ring when viewed in the top, the front and the bottom, respectively, FIG. 11(b) is a cross-sectional view taken along the line 8-8′ of FIG. 11(a), FIG. 11(c) is a view illustrating the construction of a tension spring, and FIG. 11(d) is a view illustrating the construction of a sealing support ring wherein the semi-circular piece of FIG. 11(a) is assembled in one pair;

FIG. 12 is a view illustrating the construction of a guide of FIG. 9, wherein FIG. 12(a) is a front view of the guide, FIG. 12(b) is a top plan view of FIG. 12(a), FIG. 10(c) is a bottom view of FIG. 12(a), and FIG. 12(d) is a cross-sectional view taken along the line 6-6′ of FIG. 12(c);

FIG. 13 is a view illustrating the construction of a joint of FIG. 9, wherein FIG. 13(a) is a front view of the joint, FIG. 13(b) is a bottom view of FIG. 13(a), and FIG. 13(c) is a cross-sectional view taken along the line 7-7′ of FIG. 13(b);

FIG. 14 is a view illustrating the construction of a back head of FIG. 9, wherein FIG. 14(a) is a front view of the back head, FIG. 14(b) is a bottom view of FIG. 14(a), FIG. 14(c) is a cross-sectional view taken along the line 4-4′ of FIG. 14(b);

FIG. 15 is a cross-sectional view illustrating the operational state of the pneumatic operated hammer for rock drilling of FIG. 9 according to a second embodiment of the present invention, wherein FIG. 15(a) is a view showing the flow of compressed air for the drilling work before the operation of the pneumatic operated hammer, FIG. 15(b) is a view showing the flow of compressed air for the upward movement of the piston, and FIG. 15(c) is a view showing the flow of compressed air for the downward movement of the piston;

FIG. 16 is a cross-sectional view of a pneumatic operated hammer for rock drilling in an assembly state according to a third embodiment of the present invention;

FIG. 17 is an exploded perspective view of FIG. 16;

FIG. 18 is a view illustrating the construction of a piston in FIG. 16, wherein FIG. 18(a) is a front view of the piston, FIG. 18(b) is a right side view of FIG. 18(a), and FIG. 18(c) is a cross-sectional view taken along the line S-S′ of FIG. 18(b);

FIG. 19 is a view illustrating the construction of a back head of FIG. 16, wherein FIG. 19(a) is a front view of the back head, FIG. 19(b) is a right side view of FIG. 19(a), FIG. 19(c) is a cross-sectional view taken along the line S-S′ of FIG. 19(b), and FIG. 19(d) is an enlarged view of a portion A in FIG. 19(c);

FIG. 20 is a view illustrating the construction of a joint of FIG. 16, wherein FIG. 20(a) is a front view of the joint, FIG. 20(b) is a right side view of FIG. 20(a), and FIG. 20(c) is a cross-sectional view taken along the line S-S′ of FIG. 209(b); and

FIG. 21 is a cross-sectional view illustrating the operational state of the pneumatic operated hammer for rock drilling of FIG. 16 according to a third embodiment of the present invention, wherein FIG. 21(a) is a view showing the flow of compressed air for the drilling work before the operation of the pneumatic operated hammer, FIG. 21(b) is a view showing the flow of compressed air just before the ascending of the piston, and FIG. 21(c) is a view showing the flow of compressed air for the striking at a stop point after the ascending of the piston.

### BEST MODE FOR CARRYING OUT THE INVENTION

Now, an explanation of the preferred embodiment of the present invention will be in detail given with reference to attached drawings.

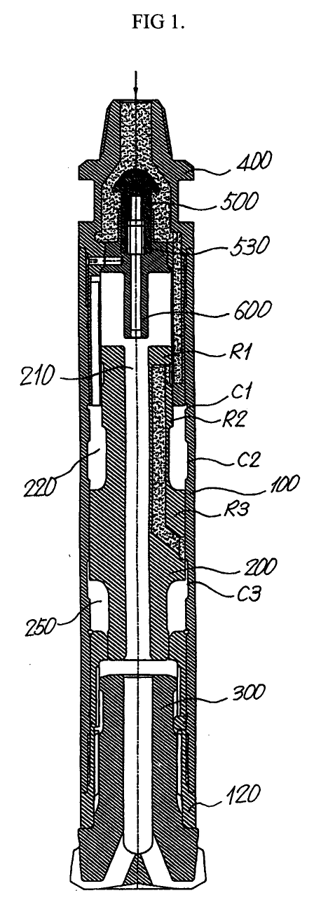

As shown in FIG. 1, a first embodiment of the present invention is implemented with a concrete shape and structure of the following components. That is, in case of a pneumatic operated hammer for rock drilling in which a piston 200 strikes a button bit 300 while vertically reciprocating in a cylindrical casing 100 so that the drilling work is carried out, a back head 400 is screw-engaged with the upper portion of the casing 100 with the back head having a center hole 410 for supply of compressed air and an inner hollow space 420 for receiving a check valve 500 therein. A guide 600 is engaged with the lower end of the check valve 500 by means of a coil spring 530 and is construed such that its shaft portion 610 advances to and retracts from an inner hole 210 of the piston 200. A chuck 120 formed integrally with a bushing portion 110 is disposed at an inner periphery of the lower end portion of the casing 100 so that the piston 200 and the button bit 300 are prevented from being shaken due to an axial play of the piston and button bit when they ascend and descend in the casing and a compressed air sealing function is effected.

Under the above structure, a driving method of the pneumatic operated hammer for rock drilling comprises: a first step of waiting for a drilling work in a load-free state even when the pneumatic operated hammer is supplied with compressed air at a drilling position; a second step of expanding variable compressed-air chambers through compressed air passageways formed between the piston 200 and the casing 100 to abruptly ascend the piston 200 in the casing; and a third step of supplying compressed air to the piston 200 positioned at a vertex point through the compressed air passageways to expand other variable compressed-air chambers between the piston 200 and the casing 100 to thereby abruptly descend the piston 200.

The chuck 120 formed with a bushing portion 110 is screw-engaged with an inner periphery of the lower end portion of the casing 100 so that the piston 200 vertically reciprocates within a range corresponding to a length limited by the chuck 120 in the casing 100. Further, the back head 400 is formed of a warhead-shaped structure that has a center hole 410 for supply of compressed air and an inner hollow space 420. The guide 600 is fastened to the inner hollow space 420 of the back head 400 in such a fashion as to be engaged integrally or separately with the back head. The check valve 500 elastically supported by a coil spring 530 is installed at the central upper portion of the guide 600 so as to open and close the center hole 410 and the inner hollow space 420 of the back head 400.

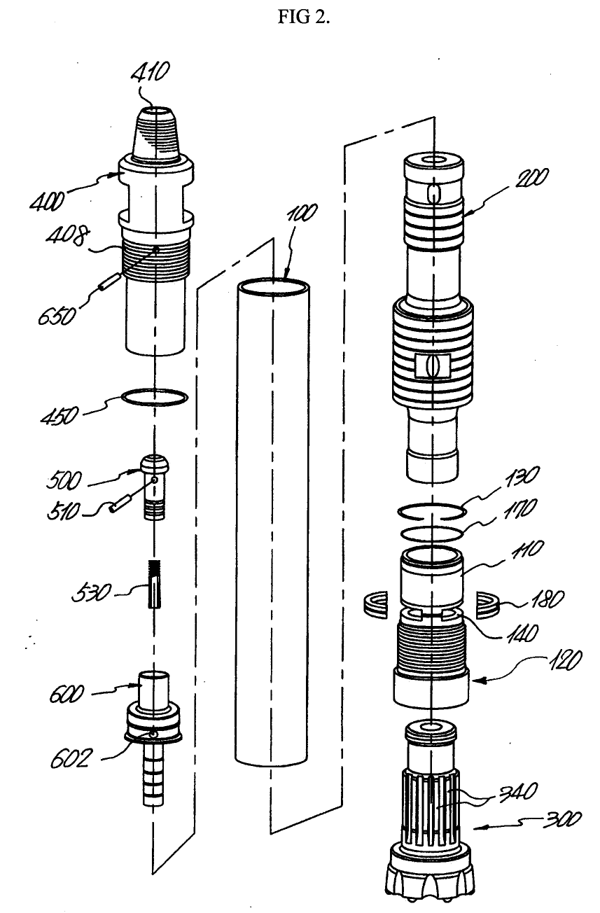

FIG. 2 is an exploded perspective view of a pneumatic operated hammer for rock drilling in an assembly state according to a first embodiment of the present invention.

Referring to FIG. 2, there are shown the back head 400 adapted to be mounted at the inner periphery of the upper end portion of the casing 100, an O-ring 450, the check valve 500, a plug 510, the coil spring 530 adapted to be mounted at inner hole 520 of the check valve 500, and the guide 600 formed at the outer peripheral surface thereof with a stopper hole 602, which are disassembled in this order. In this case, the piston 200 and the chuck 120 mounted to the lower end of the casing 100, and the button bit 300 performing the drilling work owing to the collision with the piston 200 are shown. Reference numerals which are not explained in FIG. 2, a reference numeral 110 denotes bushing, 130 denotes a stop ring, a reference numeral 140 denotes a bit retainer recess, a reference numeral 170 denotes an O-ring, a reference numeral 180 denotes a bit retainer ring, a reference numeral 340 denotes guide grooves, and a reference numeral 650 denotes a stopper for allowing the guide 600 to be engaged with the back head 400.

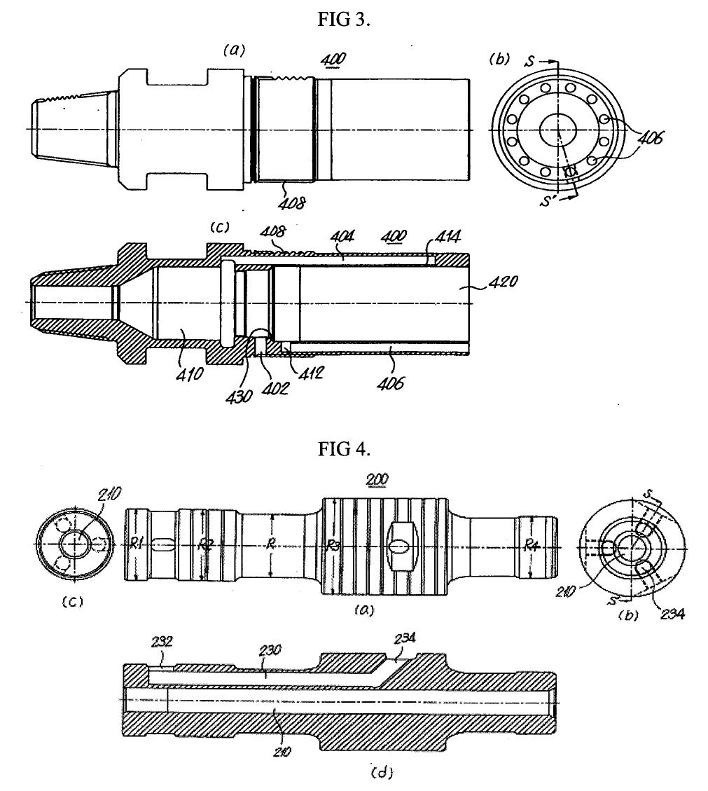

FIG. 3 is a view illustrating the construction of a back head 400 in FIG. 1, wherein FIG. 3(a) is a front view of the back head, FIG. 3(b) is a right side view of FIG. 3(a), and FIG. 3(c) is a cross-sectional view taken along the line S-S′ of FIG. 3(b).

In FIG. 3, the upper end portion of the back head 400 is formed in a hollow cylindrical and frusto-conical shape such that it can engage with an existing rotatable drill pipe string (not shown) that is supplied with compressed air. As shown I FIG. 3(c), air passageways 404 fluidically communicating with the inner hollow space 420 of the back head 400 is closed at its bottom end (the right side of the drawing), and other air passageways 406 are opened at their lower ends so that it can fluidically communicate with compressed-air chambers 220 formed between the casing 100 and the piston 200 which will be described later.

The air passageways 406 are arranged concentrically at regular intervals about a central axis of the back head 400 in such a fashion as to be spaced apart inwardly radially from the outer periphery of the back head (see FIG. 3(b)). In this case, the air passageways 406 opened at their lower ends and the air passageways 404 fluidically communicating with a center hole 422 via an outlet aperture 414 are alternately arranged concentrically. Also, the front end portion of the back head 400 is formed in a truncated-conical shape, and screw threads are formed on the outer peripheral surface of an intermediate portion of the back head 400 so that they can engage with screw threads which will be described later formed on the inner peripheral surface of a front end portion of the casing 100 by screw-engagement. A reference numeral 402 which is not explained in the drawing indicates a pin hole.

FIG. 4 is a view illustrating the construction of a piston 200 of FIG. 1, wherein FIG. 4(a) is a front view of the piston, FIG. 4(b) is a right side view of FIG. 4(a), FIG. 4(c) is a left side view of FIG. 4(a), and FIG. 4(d) is a cross-sectional view taken along the line S-S′ of FIG. 4(b) to show the inner structure of the piston 200. The piston as shown in FIG. 4(a) has a central shaft with a certain outer diameter R and a center hole 210 perforated therein. In this case, axial portions having outer diameters R1, R2, R3 and R4 greater than the outer diameter R of the central shaft are formed in such a fashion as to be different in length from one another. Therefore, as shown in FIG. 1, the piston 200 is designed such that effective sealing function is provided while minimizing the friction resistance at the contact surface between the axial portions having different outer diameters R1, R2, R3 and R4 and the axial portions having different inner diameters C1, C2 and C3, as well as the contact surface between the axial portions having different outer diameters R1, R2, R3 and R4 and the inner walls of the inner hollow space 420 of the back head 400, the bushing portion 110 of the chuck 120 and the casing 100, thereby forming compressed air chambers 250 between the piston and the casing.

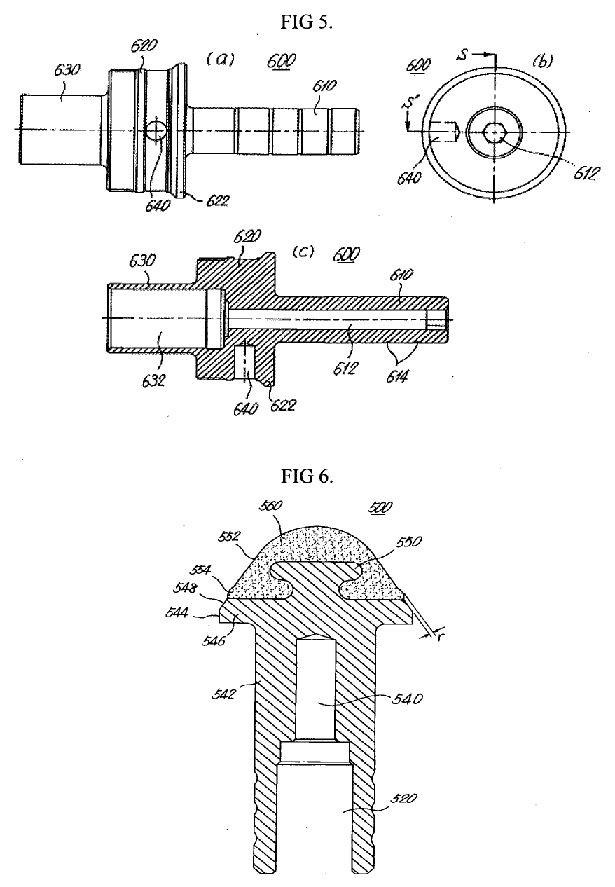

FIG. 5 is a view illustrating the construction of a guide 600 in FIG. 1, wherein FIG. 5(a) is a front view of the guide, FIG. 5(b) is a right side view of FIG. 5(a), and FIG. 5(c) is a cross-sectional view taken along the line S-S′ of FIG. 5(b).

The guide 600 includes a shaft portion 610 that advances to and retracts from the inner hole 210 of the piston 200, an intermediate anvil portion 620, and a check valve receiving portion 630 formed at an upper end portion thereof, which have different outer diameters. In addition, the anvil portion 620 has a circumferentially extending outer peripheral edge portion 622 formed at a lower portion thereof and a stopper hole 640 formed on the outer peripheral surface thereof. The shaft portion 610 has a center through-hole 612 formed therein to fluidically communicate with a receiving hole 632 of the check valve receiving portion 630. The shaft portion 610 also has a plurality of annular grooves 614 axially formed on the outer peripheral surface thereof so that when it advances to and retracts from the center hole 210 of the piston 200, maximization of a sealing function and minimization of a frictional resistance are achieved simultaneously. Particularly, the circumferentially extending outer peripheral edge portion 622 of the anvil portion 620 engages with an inner peripheral edge portion 430 of the back head 400 of FIG. 3 in a concavo-convex engagement relationship.

FIG. 6 is a cross-sectional view illustrating the construction of a check valve 500 in FIG. 1.

The check valve 500 has the following features as compared to a prior art check valve. The inventive check valve 500 includes a seating portion 542 formed with a center hole 520 and a hollow inner space 542 formed above the center hole, and a head portion 544 covered with an elastic rubber element 560. Particularly, the head portion 544 includes a skirt 546 having a slant surface 548 inclined upwardly toward its central axis at an upper end portion thereof. The head portion 544 also includes a support 550 having a diameter smaller than that of the skirt 546 and arranged horizontally above the skirt 546 in such a fashion as to be integrally spaced apart from the skirt by a certain distance, so that it has a rail-shaped cross sectional structure. In addition, the elastic rubber element 560 covered on the support 550 is contoured to have a slant surface 552 inclined at a angle parallel with the slant surface 548 of the skirt 546, and a reinforced strip portion 554 formed circumferentially at a lower end portion thereof in such a fashion as to be projected outwardly by a certain thickness (r) from a slant surface matching with the slant surface 552 of the elastic rubber element 560 and the slant surface 548 of the head portion 544.

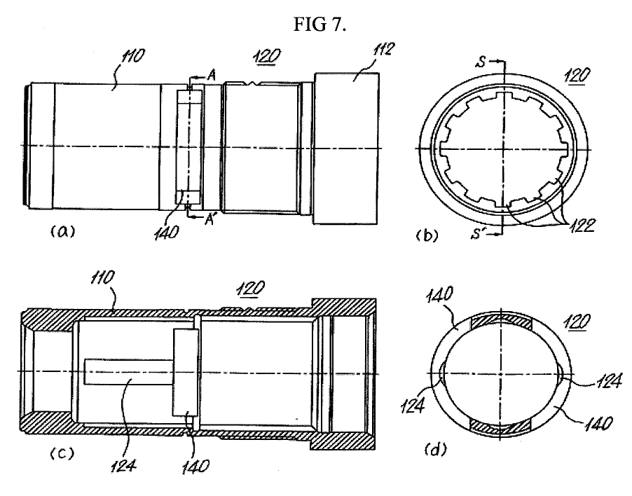

FIG. 7 is a view illustrating the construction of a drill chuck in FIG. 1, wherein FIG. 7(a) is a front view of the drill chuck, FIG. 7(b) is a right side view of FIG. 7(a), and FIG. 7(c) is a cross-sectional view taken along the line S-S′ of FIGS. 7(b), and 7(d) is a cross-sectional view taken along the line A-A′ of FIG. 7(a).

As shown in FIG. 7(a), the chuck 120 includes a bushing portion 110 and a casing contacting portion 112. An intermediate portion of the chuck 120 located between the bushing portion 110 and the casing contacting portion 112 has a bit retainer ring mounting recess 140 formed on the inner peripheral surface thereof and compressed air grooves 124 formed on the inner peripheral surface thereof (see FIGS. 7(c),(d)). Also as shown in FIG. 7(b), the casing contacting portion 112 of the chuck 120 has a plurality of guide grooves 122 formed on the inner peripheral surface thereof in such a fashion as to be spaced apart from one another at regular intervals, so that the guide grooves 122 slidably engages with a plurality of circumferential protrusions alternately arranged between the adjacent guide grooves 340 of the button bit 300 in a concavo-convex engagement relationship. FIG. 7(c) is intended to more easily show the formation of the bit retainer ring mounting recess 140 and the compressed air groves 124.

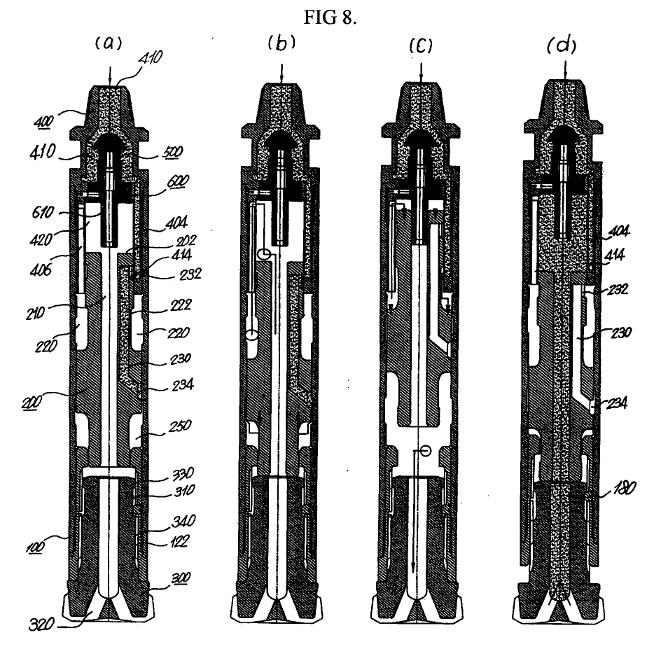

The respective components constituting the present invention as described above are assembled with one another in the positions as shown in FIG. 2 to implement the finished pneumatic operated hammer for rock drilling as shown in FIG. 1, and variable compressed air chambers 220 and 250 are formed between the casing 100 and the piston 200 as in the driving process of FIG. 8 which will be described later.

Now, a non-explained structure and the driving process of the present invention according to a first embodiment as constructed above will be described hereinafter with reference to FIG. 8.

In FIG. 8, repetitive reference numerals are omitted if necessary for the sake of avoiding the confusion of the same reference numerals.

A hammer driving process in which the pneumatic operated hammer of the present invention performs rotation, striking and drilling is identical to that of the conventional prior art. Accordingly, the rotational force of the pneumatic hammer for rock drilling is generated in a known manner, and thus the explanation thereof will be omitted. As for the present invention, the striking force of the pneumatic hammer for rock drilling is generated in such a that compressed air is supplied to the inside of the casing through the center hole 410 of the back head 400 to descend the piston 200 to thereby strike the button bit 300, which will be described hereinafter by separate steps.

For the pneumatic operated hammer assembled as shown in FIG. (8d), the piston 200 and the button bit 300 are descended by their own weights in a load-free state, in which case compressed air (indicated by numerous points) is fed to the inside of the pneumatic hammer through the inner hole 210 of the piston.

This operation is a first step of the driving process of the pneumatic operated hammer. The first step corresponds to a load-free step in which even if the pneumatic operated hammer which has prepared for a drilling work is supplied with compressed air, the drilling work is waited for, but not performed. In this load-free step, the compressed air supplied through the center hole 410 of the back head 400 overcomes the pressure of the check valve 500 abutting against a seat portion 440 and then is discharged to the outside along a compressed air flow channel running from the air passageway 404 via the inner hole 210 of the piston to a discharge hole of the button bit in a state where the piston 200 and the button bit 300 descend and are located at the lowermost position by their own weights, to thereby blow out sludge, etc., on the drilled surface without a striking effect.

A second step of the driving process of the pneumatic operated hammer corresponds to a step in which the piston 200 ascends. In this piston ascending step, when the pneumatic operated hammer descends until it reaches the drilling surface with the rotation force and the compressed air being supplied for the drilling work, as shown in FIG. 8(b), the button bit 300 and the piston 200 are pushed into the casing 100. At this time, the compressed air supplied to the pneumatic hammer from the outside by a compressor is fed to the air passageway 404 via the center hole 410 and the hollow inner space 420 of the back head 400, and hence it is supplied to outlet apertures 234 of the piston 200 via an inlet aperture 232 of the piston fluidically communicating with the outlet aperture 424 of the air passageway 404.

The compressed air is upwardly and downwardly expanded in the compressed air chamber 250, but the piston 200 abuts against the button bit 300 and the lower end portion of the button bit 300 abuts against the drilling surface such that it does not descend any more. As a result, the compressed air is expanded in a direction where the piston 200 ascends to continue to ascend the piston 200. Accordingly, the compressed air passageways run to the compressed air chambers 250 defined by the hermetic sealing of the casing 100 and the lower end of the piston 200 so that the compressed air is supplied to the compressed air chambers 250 to expand the inside space of the compressed air chambers to thereby acceleratingly ascend the piston 200. At this time, the ascending of the piston continues to be performed until the outlet aperture 234 of the piston is blocked to interrupt the supply of the compressed air to the compressed air chambers 250 as shown in FIGS. 8(b) and 8(c).

During this ascending operation of the piston 200, the air within the compressed air chamber 220 passes through the inner hole 422 and the inner hole 210 of the piston 200 through the air passageways 406 of the back head and is discharged to the outside through the discharge hole 320 of the button bit 300 as indicated by arrow in FIG. 8(c), so that the prevention of the ascending of the piston 200, i.e., a compression effect does not occur in which when the piston 200 ascends, the air is pressurized within the compressed air chamber 220 to suppress the ascending of the piston 200. The piston 200 ascends to a predetermined vertex point by the ascending inertia as shown in FIG. 8(c) so that the shaft portion 610 of the guide 600 fits into the upper portion of the inner hole 210 of the piston to block the passageway for supply of the compressed air in the compressed air chamber 220.

To describe briefly this operation, in the second step of the hammer driving process, the hammer bit descends for the drilling work and the bottom surface of the hammer bit comes in close contact with the drilling surface. In this case, when the hammer bit descends while rotating, the button bit 300 disposed at the lowermost position of the pneumatic operated hammer and the piston 200 are pushed into the inside of the casing 100. Thus, the compressed air passageway is formed of the center hole 410, the air passageway 404, and the compressed air chamber 250 of the piston. Then, the piston 200 instantaneously ascends by the compressed air.

The third step of the hammer driving process is a striking step in which the piston 200 positioned at the vertex point descends. In the third step, as in the second step, when the piston 200 ascends along the inner wall surface of the back head defining the inner hole 430 of the back head 400 at the portions having outer diameters R1, R2 thereof, and then an axial portion (see FIG. 4(a)) of having a smaller diameter between the outer diameters R, R2 and R3 reaches the outlet aperture 414 of the air passageway 404, the compressed air is introduced into the compressed air chamber 220 for the descending of piston through a clearance therebetween, i.e., a compressed air hole formed due to a difference of different outer diameters (R2 and R) of the piston 200.

Accordingly, the space in the compressed air chamber 220 is expanded rapidly to generate an expanding force to thereby descend the piston 200. Simultaneously, the compressed air inside the compressed air chamber 220 allows pressure to be applied to the top surface of the piston 200, to thereby provide a dual striking force for aiding the descending force of the piston 200. When the piston 200 descends, the compressed air remained in the space define by the bottom end of the piston, the top end of the button bit 300 and the inner wall of the casing 100 is discharged to the outside through the discharge hole 320 as shown in FIG. 8(c), so that it cannot function as a compression force for suppressing the descending of the piston 200.

Namely, the third step of the hammer driving process is a step in which the piston 200 descends in the casing 100 in a state where it positioned at the vertex point. In this third step, the compressed air is supplied to and pressurized in the inner hole 420 defined by a space on the compressed air chambers 220 and the top surface of the piston 200 through the center hole 410 and the air passageway 404 of the back head 400 so that the bottom end of the piston 200 strikes the top surface of the button bit 300 which will perform the drilling work.

Until the drilling work is completed, the second and third steps are repeatedly performed to ascend and descend the piston 200. At this time, the drilling work is carried out by the vertical striking force of the piston and the rotational operation of the entire the pneumatic operated hammer.

In this case, as shown in FIG. 7, the button bit 300 ascends and descends at a guide portion thereof formed with the guide grooves 340 along the guide grooves 122 of the chuck 120 formed integrally with the bushing portion 110, but it is terminated at the outer circumferential groove 310 thereof by a retaining step 330 thereof so that the ascending and descending length of the button bit 300 is limited to the length of the outer circumferential groove portion 31 by the bit retainer ring 180.

In the meantime, since a so-called back-flow phenomenon occurs in which underground water, etc., is introduced backward into the casing 100 during the above continuous drilling work, there is the possibility for the back-flown water to block off the frictional surface of the piston and the compressed air chambers along with the sludge. The prevention of this requires that the length (L) of the piston 200 should be set to be more than 5.7 times that of a reference outer diameter (R) (L/R=5.7), and is set to be more than 3.2 times that of a portion having the largest outer diameter R3 (L/R=3.2).

Particularly, the piston 200 is formed with axial portions having different outer diameters R1, R2(=R1), R3 and R4 so that the axial portions are in close contact with the inner wall surface of the hollow inner space 420 of the back head 400 and the inner wall surface of the casing 100. Accordingly, the horizontal shaking of the piston is prevented during the ascending and descending of the piston to thereby assist in the upward linear movement without a clearance of the piston 200. This results in an efficient improvement over the moving lines of the air flow, so that the reciprocating speed of the piston is increased to thereby provide an effect of improving the drilling work efficiency.

In the meantime, the pneumatic operated hammer driving method according to the first embodiment of the present invention essentially requires the formation of the compressed air chambers that provides a rapid and strong striking force of the piston. In order to enhance the drilling working efficiency, a second embodiment of the present invention may be constructed within the scope of the present invention as follows. (although the constitutions of the first embodiment and the second embodiment of the present invention are identical to each other within an identical scope of the prevent invention, or components of similar structure are used, different reference numerals are used for the identical components for the sake of avoiding the confusion of the same reference numerals.

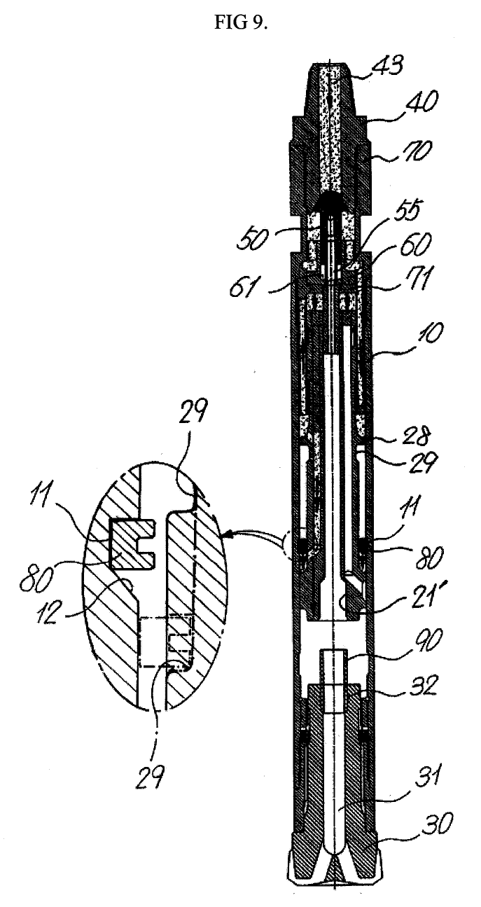

As shown in FIG. 9, in a pneumatic operated hammer for rock drilling in an assembly state according to a second embodiment of the present invention, first, the back head 40 and the casing 10 are engaged with by means of a joint 70. The reason for this is that the joint 70 is formed with a guide seating portion 71 and a compressed air groove 72 so that the guide 60 is seated from the top to the bottom of the joint 70 in the drawing to prevent the generation of a clearance due to vibration during the drilling work.

Also, a striking guide groove extending from the center hole is formed between the inner hole 21 constituting the inner diameter of a piston 20 and the outer periphery of the piston. The piston has a first chamber partition wall 28 and a second chamber partition wall 28′ positioned below the first chamber partition wall 28 protrudingly formed at the outer periphery thereof, and a sealing support ring mounting groove 29 formed just below the first chamber partition wall 28 for mounting a sealing support ring which will be described later.

In the meantime, the upper portion of the center hole 31 of a button bit 30 is formed with a support groove 32 having a diameter larger than that of the upper portion of the center hole 31 so that a center rod 90 is fixedly engaged with the support groove. The center rod 90 is fit into the striking guide groove 21′ of the piston 20 at the time of descending of the piston 20 so that the piston 20 is guided to strike the button bit 30 at a precise position, and compressed air from the inner hole 21 of the piston is supplied via the center hole 31 of the button bit so that it is rapidly discharged along with sludge.

In addition, the casing 10 has a concave depression 11 formed at the inner peripheral surface of the intermediate portion thereof for mounting the sealing support ring 80 therein. The sealing support ring 80 is formed in a doughnut shape constructed of two symmetrical semi-circular pieces so as to functions as a piston ring within a cylinder.

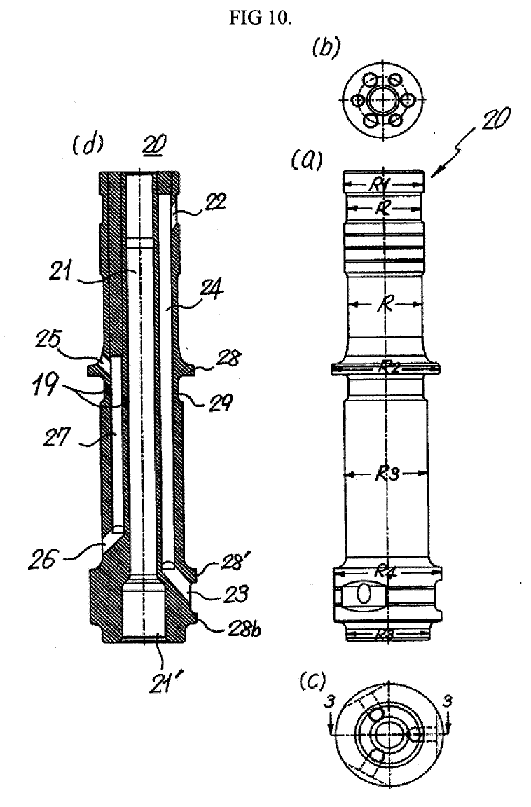

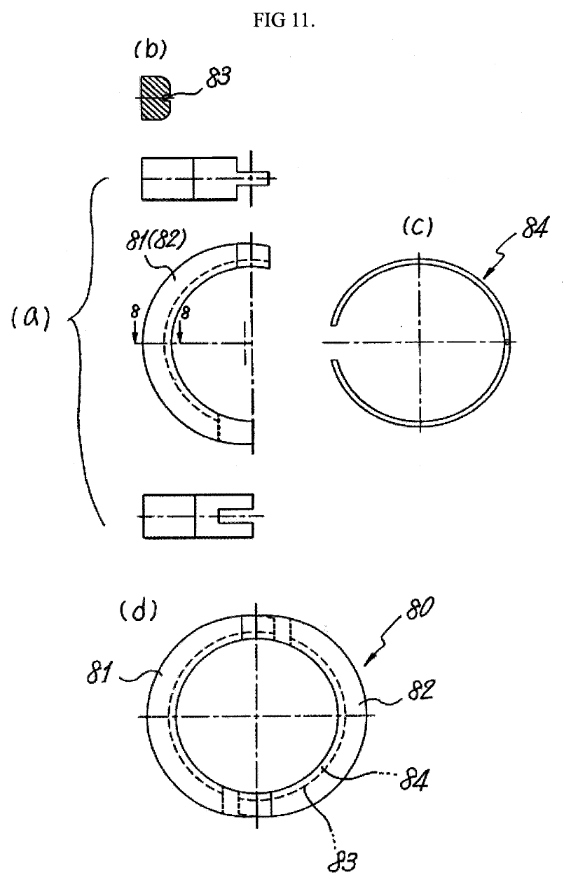

FIG. 10 is a view illustrating the construction of a piston 20 of FIG. 9. The piston 20 has a center hole perforated therein. The piston consists of different axial portions having a reference diameter R and outer diameters R1, R2, R3 and R4 different from the reference diameter R. In this case, between the inner hole 21 of the piston 20 and the outer periphery of the piston are formed a pressure-increasing passageway 24 fluidically communicating with an inlet aperture 22 and an outlet aperture 23 and a pressure-reducing passageway 27 fluidically communicating with another inlet aperture 25 and another outlet aperture 26. A reference numeral 19 denotes a through-hole.

FIG. 11 is a view illustrating the construction of a sealing support ring 80 received and mounted in the concave depression 11 of the casing 10. As shown in FIG. 11(a), a left semi-circular piece 81 and a right semi-circular piece 82 are engaged with each other to form an annular sealing support ring 80. In this case, the right and left semi-circular pieces 81 and 82 are engaged at both ends with each other in a concavo-convex engagement relationship to form an annular doughnut-shaped ring (see the upper and lower portions of a middle drawing FIG. 11(a)). As shown in FIG. 11(B), the sealing support ring 80 has a spring mounting groove 83 formed on the inner peripheral surface thereof for mounting a tension spring 84 therein as shown in FIG. 11(c) therein.

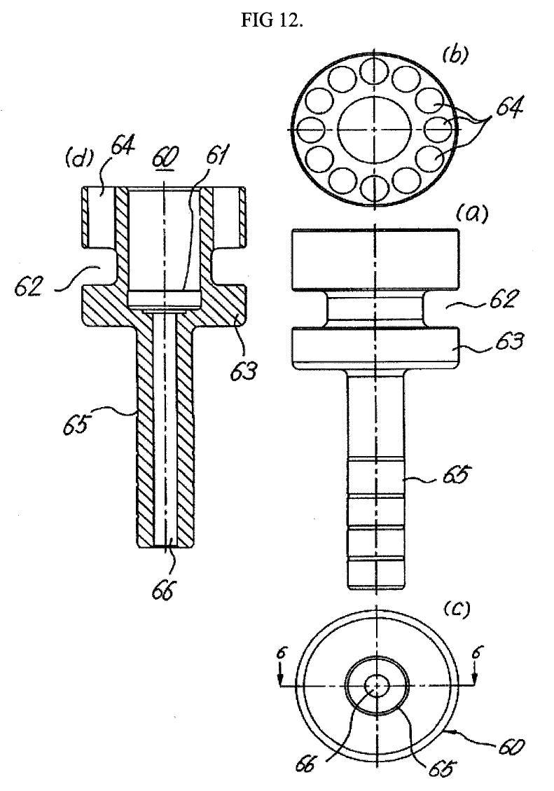

FIG. 12 is a view illustrating the construction of the guide of FIG. 9, wherein FIG. 12(a) is a front view of the guide, FIG. 12(b) is a top plan view of FIG. 12(a), FIG. 10(c) is a bottom view of FIG. 12(a), and FIG. 12(d) is a cross-sectional view taken along the line 6-6′ of FIG. 12(c). In FIG. 12, the guide 60 has a spring seating portion 61 formed therein to constitute a body, a compressed air groove 62 formed on the outer peripheral surface thereof, and a seat portion 63 formed outwardly protrudingly on the outer peripheral surface thereof.

Also, the guide has a plurality of compressed air passageways 64 formed between the spring seating portion 61 and the outer periphery thereof, and a central axial rod 65 extending downwardly from the seat portion 63 to a predetermined length and formed internally with a center hole 66.

Particularly, the plurality of compressed air passageways 64 are arranged concentrically at regular intervals about a central axis of the guide as shown in FIG. 12(b). The compressed air passageways are not limited in number to the illustrated ones, but are differently formed depending on the size of the drilling equipment and the work purpose.

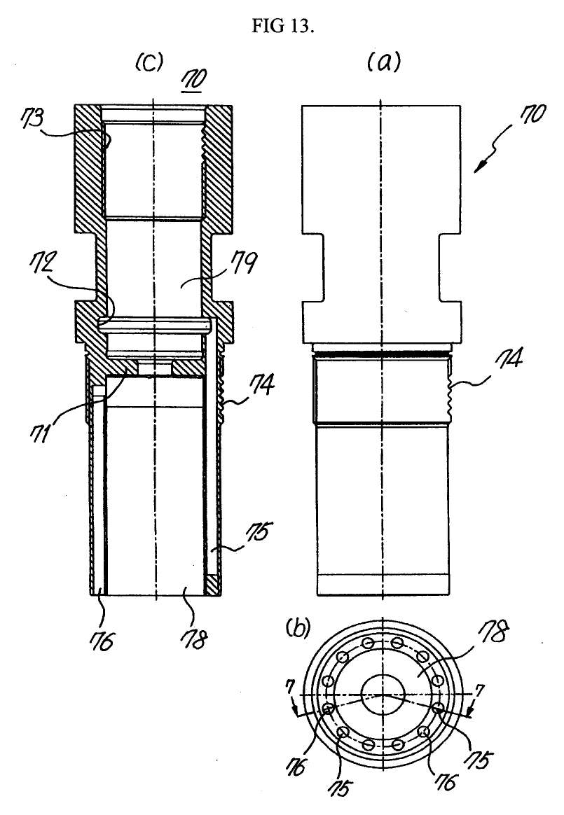

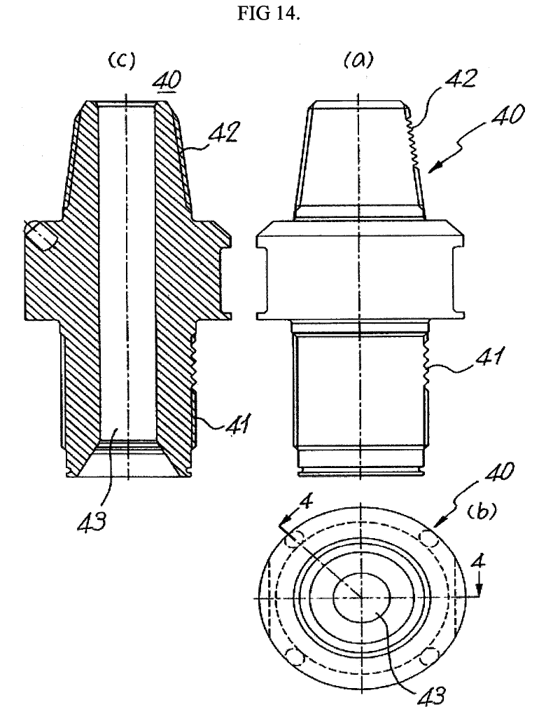

FIG. 13 is a view illustrating the construction of a joint 70 of FIG. 9.

The joint 70 serves to engage the back head 40 as shown in FIG. 14 with the casing 10. As shown in FIGS. 13 and 14, the upper portion of the joint 70 has an inner spiral engagement section 73 formed on the inner peripheral surface thereof for allowing an outer spiral engagement section 41 of the back head 40 to be engaged therewith. The lower portion of the joint 70 has an outer spiral engagement section 74 formed on the outer peripheral surface thereof for allowing the upper portion of the casing 10 to be engaged therewith. As shown in FIG. 13(c), the joint has a structural characteristic in which a plurality of compressed air passageways 75, 76 are arranged concentrically at regular intervals about a central axis of the joint between the outer periphery of the joint and a center hole 78 of the joint. In addition, as shown in FIG. 14(a) showing a front view of the back head, FIG. 14(b) showing a bottom view of FIG. 14(a), and FIG. 14(c) showing a cross-sectional view taken along the line 4-4′ of FIG. 14(b), the back head 40 has an outer engagement section 42 formed on the outer peripheral surface of a frusto-conical upper portion thereof, a center hole perforated therein, and an outer spiral engagement section 41 formed on the outer peripheral surface of a lower portion thereof for allowing the inner spiral engagement section 73 of the joint 70 to be engaged therewith.

In FIG. 9, respective components constituting the above configuration are assembled with one another. First, the piston 20 is inserted into the casing 10 in such a fashion that the sealing support ring 80 is positioned between the first chamber partition wall 28 and the second chamber partition wall 28′ of the piston 20 while being elastically seated in the concave depression 11 of the casing. Also, the guide 60 is placed on the guide seating portion 71 of the joint 70 of FIG. 13 in a state where a check valve 50 elastically supported by a coil spring 55 is seated on the spring seating portion 61 of the guide 60. When the lower portion of the joint 70 is screw-engaged with the upper portion of the casing 10, the check valve 50 is configured such that a warhead-shaped front end portion blocks off the center hole 43 at the lower portion of the back head 40. But, the center hole 43 of the back head 40 always is not blocked off by the check valve 50. The coil spring 55 is designed to conform to a certain elastic force to open/close the check valve 50 depending on a degree of the compressed air. Thus, if the compressed air reaches less than a predetermined pressure, the check valve blocks off the center hole 43 of the back head 40 by an elastic force of the coil spring 55. On the other hand, the compressed air is larger than the elastic force of the coil spring 55, a compressed air passageway is formed to supply the compressed air therethrough.

In the meantime, the construction in which the button bit 30 is mounted at the lower portion of the casing 10 will be omitted since it is shown in FIG. 1.

A process in which the sealing support ring 80 is elastically seated in and then removed from the concave depression 11 of the casing 10 will be described hereinafter.

That is, after other component parts at the lower portion of the piston 20 have been first removed, when the piston 20 is pushed downwardly, the first chamber partition wall 20 downwardly pushes the sealing support ring 80. At this time, the cross section of the concave depression 11 of the casing 10 in which the sealing support ring 80 is accommodated, as enlarged by a circle in FIG. 9, is formed with a slant groove 12 so that the sealing support ring 80 slides downwardly along the slant groove and forcibly moved toward the piston 20. As a result, the sealing support ring 80 is slidably seated in the seating support ring mounting groove 29 formed on the outer peripheral surface of the piston 20 so that it is escaped from the lower end of the casing 10 together with the piston 20.

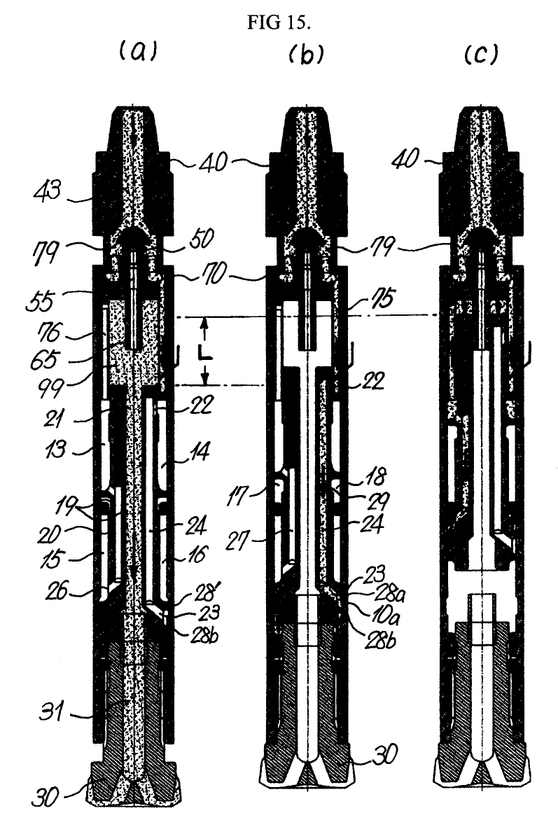

The drilling method in the second embodiment of the present invention as constructed above is identical to that in the first embodiment of the present invention. That is, in a first step, when the drilling work is prepared, as shown in FIG. 15(a), the piston and the button bit descend and are located at the lowermost position by their own weights so that although the compressed air is supplied to the pneumatic operated hammer, it is in a load-free state.

In a second step, an entire pneumatic operated hammer descends with it supplied with rotation and compressed air for the purpose of drilling earth/rock until it reaches the drilling surface. Then, as shown in FIG. 15(b), the button bit 30 and the piston 20 are pushed into the casing while forming chambers 13, 14, 15, 16, 17 and 18 divided by the first chamber partition wall 28 between the piston 20 and the casing 10.

In the meantime, the compressed air supplied by a compressor is supplied to an internal pressure chamber 79 formed inside the joint 70 via the center hole 43 of the back head 40 while pressing the check valve 50. At this time, the compressed air of the internal pressure chamber 79 is supplied to a compressed air passageway 75 formed in the joint 70.

In this case, since the piston 20 is placed in an ascended position where its inlet aperture 22 fluidically communicates with the compressed air chamber 79, the compressed air is supplied to a pressure-increasing chamber 28a via the pressure-increasing passageway 24 and the outlet aperture 23. The pressure-increasing chamber 28a is a variable space defined by a groove 10a formed on the inner peripheral surface of the casing 10 and a space formed between the second chamber partition wall 28′ and a lower partition wall of the piston 20. Since high-pressure air continues to be introduced into the pressure-increasing chamber 28a, the space in the pressure-increasing chamber is expanded to upwardly push the piston 20.

When the piston 20 is upwardly pushed, the volume of the respective chambers 13, 14, 15 and 16 is reduced and the internal air of the piston 20 is supplied to the compressed air passageway 76 of the joint 70 in fluid communicating with the chamber 13 shown at the upper left portion in the drawing. Since the compressed air is discharged to the center holes 21, 31 through a piston pressurizing chamber 99, a compression phenomenon is prevented in which the volume of the chambers is reduced.

That is, an air compressing phenomenon is eliminated at a load-free state at the time of ascending the piston 20 so that the piston 20 can ascend at a very rapid speed.

However, although the intermediate chambers 17, 18 increases in volume to form a negative pressure, a through-hole 19 prevents the generation of the negative pressure. In the contrary, a phenomenon is prevented in which pressure increases due to an increase in volume of the intermediate chambers 17, 18.

In a third step, after the piston 20 reaches a vertex position of a piston ascending and descending length in which the ascending of the piston 20 stops, it strikes the button bit 30. In other words, the compressed air is supplied to the internal chamber 79, the compressed air passageway 75, and the upper right and left chambers 13, 14 in this order, and simultaneously it passes through the pressure-reducing chamber 27 of the piston 20 to be supplied to the lower right and left chambers 15, 16 via the outlet aperture 26, thereby generating pressure for instantaneously descending the piston 20. Accordingly, the piston 20 strikes the button bit 30 with its rapid and strong striking force.

As such, in the second embodiment of the present invention, one variable chamber is further formed between the casing and the piston, and the drilling hammer is manufactured by combining the component parts of the shape and structure which can form a compressed air passageway for supplying the compressed air to the variable chamber so that the drilling work can be performed by a rapid and strong striking force of the piston.

While the construction and operation of the first and second embodiment of the present invention has been designed on a large-capacity basis, a third embodiment of the present invention provides a pneumatic operated hammer for use in a medium and small-sized drilling work.

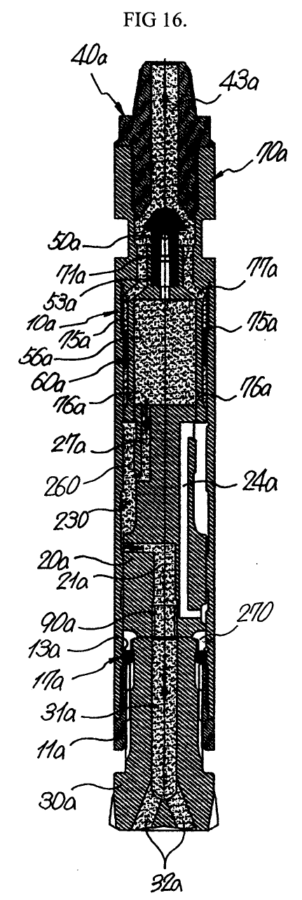

The drilling hammer according to the third embodiment of the present invention, as shown in FIG. 16 to FIG. 21, includes a back head 40a to which compressed air is supplied from the outside, a joint 70a for engaging the back head 40a with a casing 10a, a check valve 50a installed inside the joint 70a for selectively interrupting the supply of the compressed air, a cylindrical guide 60a for supporting the check valve 50a, a piston 20a adapted to ascend and descend within the casing 10a and the guide 60a and having a plurality of compressed air passageways formed therein, and a button bit 30a mounted in such a fashion as to ascend and descend in the casing 10a for performing the drilling work through a descending striking force of the piston 20a and a rotational force of the casing 10a.

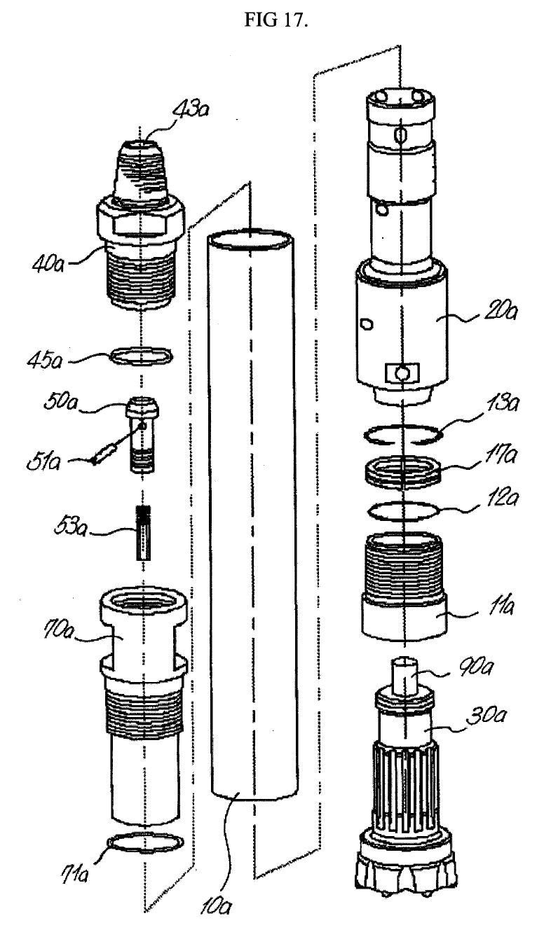

FIG. 17 is an exploded perspective view of a pneumatic operated hammer for rock drilling according to a third embodiment of the present invention.

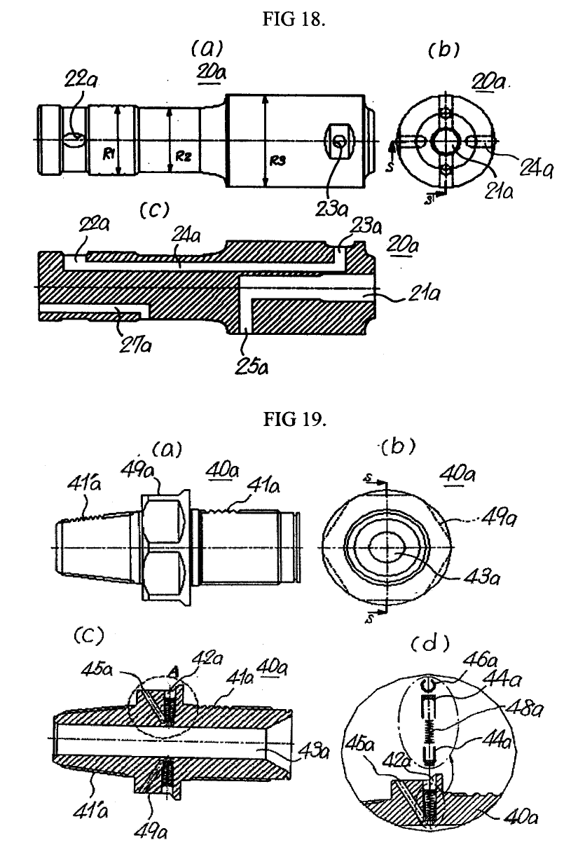

In FIG. 17, the back head 40a and the casing 10a are screw-engaged with each other by means of the joint 70a. The check valve 50a, which is located at the lower end of the compressed air passageway 43a of the back head and is elastically supported by a spring 53a, is supported by the inner periphery of a warhead-shaped front end of the guide 60a (see FIG. 16), so that the compressed air from the compressed air passageway 43a pushes the spring 53a downwardly to form a passageway for supplying the compressed air therethrough. Non-explained reference numerals 45a and 71a in FIG. 17 denote O-rings, 51a denotes a plug. In addition, as shown in FIG. 18, the piston 20a mounted at an intermediate portion of the casing 10a includes axial portions having different outer diameters R1, R2 and R3 so that it can strike the button bit 30a.

At the lower end of the casing 10a is mounted a chuck 11a together with a stop ring for the piston 20a, a retainer ring 17a for the button bit 30a, an O-ring 21a so that the button bit 30a can ascend and descend along the inner periphery of the chuck 11a.

FIG. 18 is a view illustrating the construction of a piston 20a of the pneumatic operated hammer according to the third embodiment of the present invention, wherein FIG. 18(a) is a front view of the piston, FIG. 18(b) is a right side view of FIG. 18(a), and FIG. 18(c) is a cross-sectional view taken along the line S-S′ of FIG. 18(b). The piston 20a is a weight body including axial portions having different outer diameters R1, R2 and R3. The piston 20a has a compressed air passageway 24a formed therein in such a fashion as to fluidically communicate with an inlet aperture 22a and an outlet aperture 23a, a center hole 21a formed therein to be in fluid communication with another inter aperture 25a, and a separate compressed air passageway 27a formed therein. The outlet aperture 23a, as shown in FIG. 18(b), is formed in all directions about a central axis of the piston so that the compressed air passageway 24a is formed radially.

FIG. 19 is a view illustrating the construction of a back head of FIG. 16, wherein FIG. 19(a) is a front view of the back head in which its appearance forms a warhead shape, FIG. 19(b) is a right side view of FIG. 19(a), FIG. 19(c) is a cross-sectional view taken along the line S-S′ of FIG. 19(b), and FIG. 19(d) is an enlarged view of a portion A in FIG. 19(c).

In FIG. 19, the back head 40a has spiral engagement sections 41a, 41a′ formed on the outer peripheral surfaces of the upper portion and the lower portion thereof so as to engage with other components, and a nut portion 49a formed on the outer periphery of an intermediate portion thereof. The back head 40a has a center hole 43a formed therein for supplying compressed air therethrough.

Also, the nut portion 49a has a component assembling hole 42a and a bypass hole 45a formed therein in such a fashion as to fluidically communicate with the center hole 43. A valve 44a is elastically supported by a spring 48a in the component assembling hole 42a and is terminated by a snap ring 46a. Thus, in the case where there is a limitation in treating sludge only with compressed air consumed in the pneumatic hammer upon the high-level drilling work, the compressed air is discharged to the outside through the bypass hole 45a so as to facilitate the treatment of the sludge and obtain an effect of enhancing a penetration rate. In the meantime, the nut portion 49a is formed in a hexagonal shape in the FIG. 19, but is not limited thereto. Also, other components may be formed in a symmetrical position as shown in FIG. 19(c) along with the bypass hole 45a or may be formed at respective hexagonal corners of the nut portion 49a.

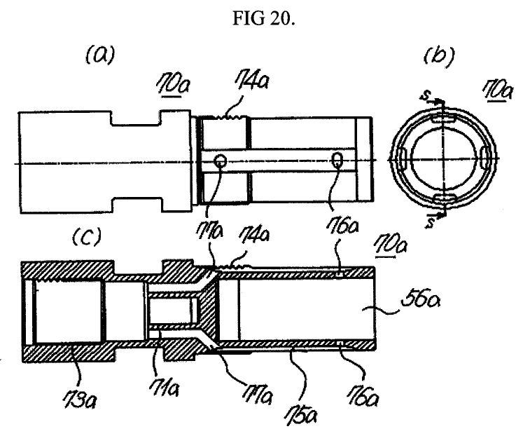

FIG. 20 is a view illustrating the construction of a joint 70a of the pneumatic operated hammer according to the third embodiment of the present invention, wherein FIG. 20(a) is a front view of the joint, FIG. 20(b) is a right side view of FIG. 20(a), and FIG. 20(c) is a cross-sectional view taken along the line S-S′ of FIG. 209(b).

Referring to FIG. 20, the joint 70a includes an inner spiral engagement portion 73a formed on the inner peripheral surface of an upper portion thereof for allowing the outer spiral engagement portion 41a of the back head 40a to be engaged therewith, and an outer spiral engagement portion 74a formed on the outer peripheral surface of a lower portion thereof for allowing the upper end portion of the casing 10a to be engaged therewith. In addition, the joint 70a includes a guide member 71a formed therein, and a compressed air inlet aperture 77a is formed between the guide member 71a and the outer periphery of the joint 70a to thereby form a compressed air passageway 75a fluidically communicating with a compressed air outlet aperture 76a between the joint 70a and the casing 10a. The cross-section of the drilling pneumatic hammer according to the third embodiment of the present invention in which above components are assembled with one another and finished is shown in FIG. 16.

In FIG. 16, the drilling pneumatic hammer is vertically oriented for the purpose of the drilling work. The back head 40a is engaged with the joint 70a, and the check valve 50a is seated in the guide member 71a of the joint 70a with it elastically supported by the spring 53a. The compressed air passageway 75a is formed between the joint 70a and the casing 10a in a state where the joint 70a has been screw-engaged with the casing. In addition, the joint 70a is formed in a cylindrical shape to form a compressed air chamber 56a at the lower portion thereof.

Meanwhile, a variable compressed air chamber 260 is formed between the casing 10a and the piston 20a so as to fluidically communicate with a compressed air passageway 27a of the piston 20a, and another variable compressed air chamber 270 is formed between the casing 10a and the piston 20a so as to fluidically communicate with another compressed air passageway 24a of the piston 20a. Also, the compressed air inlet aperture 25a of the piston 20a forms a compressed air passageway together with an inner diameter hole 230 formed by varying the thickness of the casing 10a. The center hole 21a of the piston 20a is formed in such a fashion that a lower portion thereof is larger in diameter than an upper portion thereof to allow a shaft 90a mounted on the button bit 30a to be fit thereto. Further, the stop ring 13a for the piston and the retainer ring 17a for the button bit are assembled along with the chuck 11a without a clearance of the button bit 30a so that the striking operation due to the ascending and descending of the piston can be performed. In addition, a center hole 31a is centrally formed in the button bit so that when the center hole 31a fluidically communicates with the center hole 21a of the piston 20a, the compressed air is discharged to the outside via a discharge hole 32a to thereby blow out sludge.

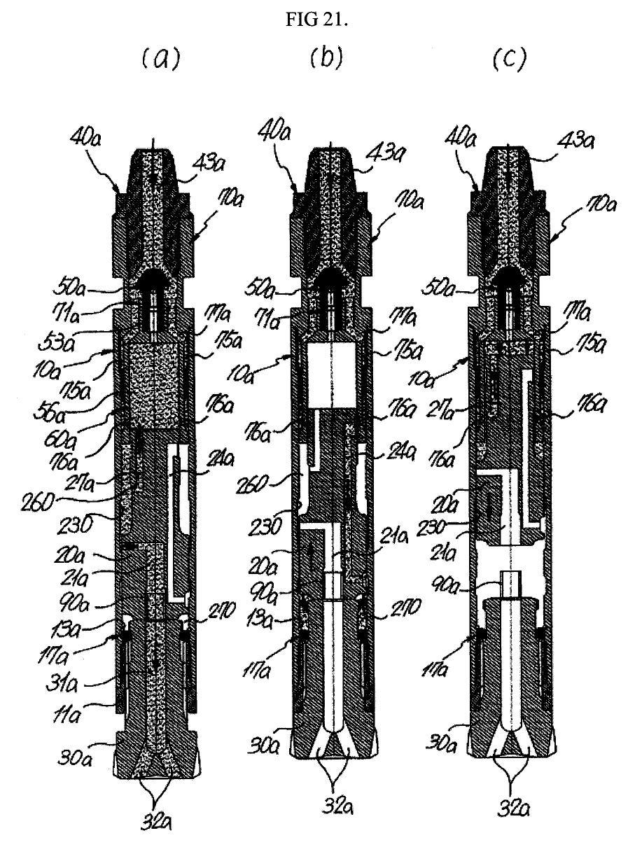

The driving process of the drilling pneumatic hammer according to the third embodiment of the present invention is shown in FIG. 21. The drilling operation in which the piston 20a downwardly strikes the button bit 30a by means of the compressed air while the pneumatic hammer rotates is identical to that in the first and second embodiments.

As shown in FIG. 21(a), in the hammer that is prepared for the drilling work, the piston 20a and the button bit 30a descend by their own weights. At this time, the compressed air flows along a discharge passageway formed in one direction as indicated by a sold arrow. When the drilling work begins, as shown in FIG. 5(b), the bottom end surface of the button bit 30a comes into close contact with the drilling surface (not shown) while entire hammer rotatably descends so that the button bit 30a is inserted into the inside of the casing 10a. Such a drilling operation is also identical to that in other embodiments.

The compressed air supplied to the pneumatic hammer from the outside for the purpose of the drilling work passes through the center hole 43a and pressurizes the check valve 50a. Thereafter, the compressed air is transported to the compressed air inlet aperture 77a formed between the guide member 71a of the joint 70a and the outer periphery of the joint 70a. At this time, the compressed air continues to be supplied to the piston until its pressure exceeds the elastic force of the support spring 53a. When the check valve 50a is shut off, the back flow of the compressed air is prevented so that the check valve 50a can perform a function of supplying the compressed air in one direction.

The compressed air introduced into the back head, as shown in FIG. 21(b), passes through the compressed air passageway 75a defined by a space between the upper portion of the casing 10a and the outer periphery of the guide member 71a via the compressed air inlet aperture 77a of the joint 70a, and then is fed to the compressed air outlet aperture 76a to be supplied to the compressed air chamber 270 through the compressed air passageway 24a of the piston 20a. An increase in pressure of the compressed air expands the compressed air chamber 270, whereas the compressed air in another compressed air chamber 56a is discharged to the outside via the compressed air passageway 27a, the variable compressed air chamber 260, the center hole 21a and the center hole 31a in this order. Therefore an ascending suppression of the piston 20a due to the remaining compressed air in the hammer is prevented.

As such, the compressed air that expands the compressed air chamber 270, as shown in FIG. 21(c), continues to be supplied to the piston until the piston 20a ascends to the vertex point so that the compressed air inlet aperture 77a, the compressed air outlet aperture 76a and the compressed air passageway 27a are fluidically communicate with one another. When the pressure increases due to continuous supply of the compressed air, the area of the compressed air chamber 56a in the guide member 71a abruptly increases to thereby abruptly descend the piston 20a due to the instantaneous pressure. Such a continuous striking of the piston due to the ascending and descending of the piston 20a allows the button bit 30a to perform the drilling work.

As described above, the pneumatic operated hammer of the third embodiment of the present invention is designed such that the piston can ascend and descend through the conversion of the compressed air passageway and the pressure variation of the compressed air chamber. Accordingly, the number of component pairs is reduced, the drilling work efficiency is enhanced due to simplicity of the structure, and the time and cost required for maintenance and repair of the drilling equipment is greatly saved.

### INDUSTRIAL APPLICABILITY

As set forth in the foregoing, the compressed air required for the drilling work is supplied to the piston through air passageways arranged concentrically at regular intervals at a central axis of the back head, and is expanded in the compressed air chambers to thereby ascend and descend the piston. The present invention has a merit in that through such a simple operation principle, an efficiency of the drilling work is significantly enhanced to thereby facilitate maintenance and repair of the drilling equipment and save the time and cost required for the drilling work.

Particularly, a conventional prior art pneumatic operated hammer has a demerit in that when the piston ascends by the compressed air, the compressed air chambers are pressurized to apply a load that suppresses the ascending of the piston. However, the present invention has an advantageous effect in that since the compressed air is supplied to the hammer in a load-free state without any pressurization of the compressed air chamber at the time of ascending the piston, the piston abruptly ascends and its striking force is increased by the compressed air effected in the variable compressed air chambers even upon the descending of the piston.

Further, the piston is designed for prevention of the back flow of water such that a second chamber partition wall is formed in the piston, the inner space thereof extends to the outlet aperture to form the pressure-increasing passageway, thereby performing more rapid ascending operation of the piston. In addition, when the ascending operation is switched to the descending operation, the compressed air instantaneously descends the piston to thereby obtain a striking force increased upon the rapid ascending and descending of the piston so as to further improve the speed of the drilling work.

Furthermore, it is possible to utilize a small-capacity drilling hammer or a medium and large-capacity drilling hammer depending on the work scale, thereby improving the drilling work efficiency and saving the time and cost required for the maintenance and repair of the drilling equipment.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A pneumatic operated hammer for rock drilling in which a piston strikes a button bit while being operated by compressed air in a cylindrical casing rotatably descending so that the drilling work is carried out, the pneumatic operated hammer comprises:
a back head screw-engaged with an upper portion of the casing;
a guide fit into a center hole of the back head, the guide including a shaft portion formed at the lower portion thereof, an intermediate anvil portion, and a check valve receiving portion formed at an upper end portion thereof, the anvil portion having a circumferentially extending outer peripheral edge portion formed at a lower portion thereof and a stopper hole formed on the outer peripheral surface thereof, the shaft portion having a plurality of annular grooves axially formed on the outer peripheral surface thereof;
a check valve received in the check valve receiving portion of the guide in such a fashion as to be elastically supported by a coil spring;
a piston adapted to ascend and descend in the casing, the piston including a center hole and a compressed air passageway formed therein, and axial portions having a reference outer diameter R and different outer diameters R1, R2(=R1), R3 and R4;
a chuck adapted to guide the piston to prevent the escape of the piston from the casing and formed integrally with a bushing portion, the chuck having a bit retainer ring mounting recess formed on the inner peripheral surface of an intermediate axial portion thereof and a plurality of guide grooves formed on the inner peripheral surface of a lower end portion thereof;
a button bit having a plurality of circumferential protrusions alternately arranged between adjacent ones of a plurality of guide grooves formed on the outer peripheral surface thereof so as to slidably engage with the guide grooves of the chuck, the button bit having an outer circumferential groove formed on the outer peripheral surface thereof and a retaining step formed at the upper end of the circumferential groove thereof so that the ascending and descending length of the button bit is limited to the length of the outer circumferential groove;
the casing screw-engaged at the upper end portion thereof with the back head, the casing having axial portions having different inner diameters C1, C2 and C3; and
a variable compressed air chamber formed between the outer periphery of the piston and the inner periphery of the casing.

2. The pneumatic operated hammer as set forth in claim 1, wherein the back head is configured such that a plurality of air passageways fluidically communicating with a center hole of the back head are arranged concentrically at regular intervals about a central axis of the back head in such a fashion that they are spaced apart inwardly radially from the outer periphery of the back head, wherein the plurality of air passageways are configured such that air passageways opened at lower ends thereof and fluidically communicating with the center hole via an inlet aperture, and air passageways closed at lower ends thereof and fluidically communicating with the center hole via an outlet aperture are alternately arranged concentrically.

3. The pneumatic operated hammer as set forth in claim 1, wherein the check valve includes a seating portion formed with a center hole and a hollow inner space formed above the center hole, and a head portion disposed on the seating portion and covered with an elastic rubber element, wherein the head portion includes a skirt having a slant surface inclined upwardly toward its central axis at an upper end portion thereof and the elastic rubber element, the elastic rubber element being contoured to have a slant surface inclined at a angle parallel with the slant surface of the skirt and a reinforced strip portion formed circumferentially at a lower end portion thereof in such a fashion as to be projected outwardly by a certain thickness (r) from a slant surface matching with the slant surface of the elastic rubber element and the slant surface of the head portion.

4. The pneumatic operated hammer as set forth in claim 1, wherein the length (L) of the piston is set to be more than 5.7 times a reference outer diameter (R) (L/R=5.7), and is set to be more than 3.2 times the largest outer diameter R3 (L/R=3.2), thereby preventing an erroneous operation due to the back-flow of water into the button bit.

5. A method of driving a pneumatic operated hammer for rock drilling in which a piston strikes a button bit while vertically reciprocating in a cylindrical casing rotatably descending so that the drilling work is carried out, the method comprises:
a first step of waiting for the drilling work in a load-free state even when the pneumatic operated hammer is supplied with compressed air at a drilling position;
a second step of forming a compressed air passageway to expand a variable compressed-air chamber formed between the piston and the casing to thereby ascend the piston in the casing; and
a third step of forming a compressed air passageway to expand another variable compressed-air chamber formed between the piston and the casing to thereby abruptly descend the piston, whereby the drilling work is performed.

6. The method as set forth in claim 5, wherein the first step comprises a step in which the compressed air supplied through a center hole of a back head overcomes the pressure of a check valve and then is discharged to the outside along a compressed air flow channel running from an air passageway via a center hole of the piston to a discharge hole of the button bit in a state where the piston and the button bit descend and are located at the lowermost position by their own weights;
the second step comprises a step in which when the casing descends while rotating for the drilling work and the bottom surface of the hammer bit comes into close contact with the drilling surface, the button bit and the piston are pushed into the inside of the casing, and the compressed air is supplied along the compressed air flow channel formed of the center hole of the back head, the air passageway, and a pressure-increasing chamber of the piston to thereby suddenly ascend the piston; and
the third step comprises a step in which in a state where the piston suddenly ascended is positioned at the vertex point, the compressed air is supplied to and pressurized in a center hole defined by a space on the compressed air chambers and the top surface of the piston through the center hole and the air passageway of the back head so that the piston abruptly descends to cause the bottom end of the piston to strike the top surface of the button bit.

7. The method as set forth in claim 5 further comprises:
a step in which the compressed air supplied from the outside is fed to the center hole of the piston through the check valve;
a step in which the compressed air in the center hole of the piston is selectively supplied to the pressure-increasing chamber of the piston in a central and distributed manner; and
a step in which the compressed air chambers are formed between axial portions having different outer diameters of the piston and the inner wall of the casing.

8. The method as set forth in claim 7 further comprises:
a step in which a plurality of air passageways are arranged concentrically at regular intervals about a central axis of the back head around the center hole of the back head for supplying the compressed air therethrough in the central and distributed manner;
a step in which a compressed air chamber used for descending the piston is formed to fluidically communicate with the air passageways;
a step in which a compressed air chamber used for ascending the piston is formed to selectively fluidically communicate with the air passageways, and the air passageways fluidically communicating with the compressed air chamber used for descending the piston and the air passageways selectively fluidically communicating with the compressed air chamber used for ascending the piston are arranged alternately concentrically around the center hole of the back head;
a step in which a compressed air supply system used for descending the piston is constructed to effect in the compressed air chamber and on the top surface of the piston; and
a step in which the button bit is engaged with a chuck such that it can slide along guide grooves formed on the inner peripheral surface of the chuck, whereby the ascending and descending operation for the drilling work is performed.

9. A pneumatic operated hammer for rock drilling, the hammer comprising a cylindrical casing, a back head mounted at an upper portion of the casing, a check valve for opening/closing a compressed air passageway in the casing, a guide for supporting the check valve, a piston adapted to ascend and descend with compressed air in the casing, and a button bit for performing a drilling work through the striking of the piston,
wherein a cylindrical joint is further provided between the casing and the back head to engage the casing with the back head, the joint being formed at a center thereof with a guide seating portion having a through-hole formed therein, wherein joint is formed on the inner peripheral surface of an upper portion thereof with an inner spiral engagement section, is formed on the outer peripheral surface of a lower portion thereof with an outer spiral engagement section, and is formed around a center hole thereof with a plurality of compressed air passageways, and wherein the casing is formed on the inner peripheral surface of an upper portion thereof with an inner spiral engagement section for screw-engaging with the outer spiral engagement section of the joint, and is formed on the inner peripheral surface of a central portion with a concave depression and a slant groove extending downwardly from the concave depression,
wherein the piston is formed in a cylindrical shaped structure having axial portions with a reference diameter R and different outer diameters R1, R2, R3 and R4 and has a center hole and a striking guide groove formed therein, a pressure-increasing passageway is formed between the center hole of the piston and the outer periphery of the piston in such a fashion as to be in parallel with the center hole and fluidically communicate with an inlet aperture and an outlet aperture, first and second chamber partition walls and a lower partition wall are formed on the outer periphery of the piston, a sealing support ring mounting groove is formed just below the first chamber partition wall, and a pressure-reducing passageway is formed inwardly from the first chamber partition wall in such a fashion as to fluidically communicate with an inlet aperture and an outlet aperture, and
wherein the button bit is formed on the inner peripheral surface of an upper portion thereof with a support groove having a diameter slightly larger than that of the upper portion of the center hole of the button bit so that a center rod is fixedly engaged with the support groove, wherein a sealing support ring is mounted in the concave depression of the casing, is formed in a doughnut shape constructed of two symmetrical semi-circular pieces so as to functions as a piston ring within a cylinder and has a spring mounting groove formed on the inner peripheral surface thereof for mounting a tension spring therein, wherein after the above components have been engaged with one another, a variable compressed air supply passageway is formed by a variable compressed air chamber formed between the casing and the piston, a piston pressurizing chamber formed between the upper portion of the piston and the center hole of the joint, and an internal pressure chamber formed between the guide seating portion of the joint and the guide seating portion below the back head in the joint so that the piston can abruptly ascend in the casing, and the drilling work is performed by an repetitive striking operation of the piston against the button bit upon the abrupt descending of the piston.

10. The pneumatic operated hammer as set forth in claim 9, wherein the compressed air supplied to the variable compressed air chamber is supplied to a compressed air flow channel formed of the center hole, the internal pressure chamber, the compressed air passageway, the piston pressurizing chamber and the center hole in this order when the piston and the button bit are located at the lowermost position in the casing, wherein when the entire casing descends for drilling, the button bit and the piston are upwardly pushed into the casing and the compressed air flow channel is formed of the center hole, the internal pressure chamber, the compressed air passageway, a pressure-increasing passageway and a pressure-increasing chamber in this order so that the volume of the pressure-increasing chamber is abruptly expanded to thereby instantaneously ascend the piston, and when the piston ascending reaches the vertex point, a compressed air flow channel is formed of the center hole, the internal pressure chamber, the compressed air passageway, the piston pressurizing chamber and the variable compressed air chamber in this order in a state where the center hole of the piston is block off by a central axial rod of the guide so that the piston abruptly descends due to an abrupt expansion of the inner space of the piston pressurizing chamber and the variable compressed air chamber to strike the button bit to thereby perform the drilling work.

11. The pneumatic operated hammer as set forth in claim 9, wherein the piston is formed on the sealing support ring mounting groove thereof with a through-hole fluidically communicating with the center hole so that compression or negative pressure are not generated in the variable compressed air chamber.

12. The pneumatic operated hammer as set forth in claim 9, wherein the slant groove is formed on the concave depression of the casing and the sealing support ring mounting groove is formed on the outer periphery of the piston so that the sealing support ring elastically supported is removed from the piston upon the separation of the piston from the casing.

13. A pneumatic operated hammer for rock drilling, the hammer comprising a back head to which compressed air is supplied from the outside, a joint for engaging the back head with a casing, a cylindrical guide mounted inside the joint for supporting a check valve and selectively interrupting the supply of the compressed air, a piston adapted to ascend and descend inside the guide engaged with the casing and having a plurality of compressed air passageways formed therein, and a drill bit mounted at the lower portion of the piston for performing the drilling work with a rotational force and a striking force of the piston, wherein the back head is screw-engaged with an upper portion of the joint, the joint is screw-engaged at a lower portion thereof with an upper portion of the casing, the lower portion of the casing is contoured to screw-engage with a chuck, a bit retainer ring for limiting an advancing and retracting range of the button bit and the chuck is mounted inside the lower end portion of the casing,
wherein the piston is a weight body including axial portions having different outer diameters R1, R2 and R3, the piston having a compressed air passageway formed therein in such a fashion as to fluidically communicate with an inlet aperture and an outlet aperture, a center hole formed therein to be in fluid communication with another inter aperture, and a separate compressed air passageway formed therein,
wherein the back head has spiral engagement sections formed on the outer peripheral surfaces of the upper portion and the lower portion thereof so as to engage with other components and a nut portion formed on the outer periphery of an intermediate portion thereof, the back head having a center hole formed therein for supplying compressed air therethrough, the nut portion having a component assembling hole and a bypass hole formed therein in such a fashion as to fluidically communicate with the center hole, and a valve is elastically supported by a spring in the component assembling hole and is terminated by a snap ring,
wherein the joint includes an inner spiral engagement portion formed on the inner peripheral surface of an upper portion thereof for allowing the outer spiral engagement portion of the back head to be engaged therewith, an outer spiral engagement portion formed on the outer peripheral surface of a lower portion thereof for allowing the upper end portion of the casing to be engaged therewith, and a guide member formed therein, and a compressed air inlet aperture is formed between the guide member and the outer periphery of the joint to thereby form a compressed air passageway between the guide member and the casing, so that in a state where a drilling work is prepared, a compressed air flow channel is formed of the center hole of the hack head, the compressed air inlet aperture formed between the guide member and the joint, a compressed air passageway of the guide, the compressed air passageway of the piston, the center hole of the piston and the center hole of the button bit in this order, so that in a state where the piston ascends, the compressed air flow channel is formed of the center hole of the back head, the compressed air inlet aperture formed between the guide member and the joint, a compressed air passageway formed by a space defined between the upper portion of the casing and the outer periphery of the guide, a compressed air outlet aperture formed between the guide member and the joint, the compressed air passageway of the piston and a variable compressed air chamber formed the piston and the casing in this order, and the compressed air in other compressed air chamber is discharged to the outside through the compressed air passageway of the piston, the compressed air chamber of the piston and the center hole of the button bit to thereby abruptly ascend the piston in a load-free state, and so that in a state where the piston descends, the compressed air continues to be supplied to the piston until the compressed air inlet aperture formed between the guide member and the joint, the compressed air outlet aperture formed between the guide member and the joint and the compressed air passageway of the piston are fluidically communicate with one another, and then the area of the compressed air chamber in the guide member is abruptly expanded to thereby abruptly descend the piston due to the instantaneous pressure to strike the button bit, thereby allowing the button bit to perform the drilling work.

14. The pneumatic operated hammer as set forth in claim 13, wherein the outlet aperture of the piston is formed in all directions about a central axis of the piston.

15. The pneumatic operated hammer as set forth in claim 13, wherein the bypass hole, the component assembling hole and components mounted in the component assembling hole are formed at respective hexagonal corners of the nut portion or at symmetrical hexagonal positions of the nut portion.
